(19) United States
(12) Patent Application Publication
(10) Pub. No.: US 2024/0208171 A1
(43) Pub. Date: Jun. 27, 2024

(54) Novel Heat Press Machine

(71) Applicant: Dongguan Yifei Thermal Transfer Printing Technology Co., LTD., Dongguan City (CN)

(72) Inventor: Zhiyong Zhang, Xiaogan City (CN)

(21) Appl. No.: 18/131,418

(22) Filed: Apr. 6, 2023

(30) Foreign Application Priority Data
Dec. 23, 2022 (CN) 202211664522.2

(51) Int. Cl. B30B 15/14; B30B 1/04; B30B 15/06

(52) U.S. Cl. CPC B30B 15/14; B30B 1/04; B30B 15/064

(57) ABSTRACT

A heat press machine, includes an upper frame body and a lower frame body, wherein a heating plate is arranged in the upper frame body, a lower plate is arranged in the lower frame body, the rear end of the upper frame body is hinged with the rear end of the lower frame body, an elastic assembly is arranged between the rear end of the upper frame body and the rear end of the lower frame body. The elastic assembly makes the upper frame body and the lower frame body open at an acute angle in a natural state; self-locking mechanisms are arranged at the front end of the upper frame body and the front end of the lower frame body, the upper frame body is pressed down so the lower frame body is covered with the upper frame body, the heating plate and the lower plate are kept closed.

### CROSS REFERENCE TO RELATED APPLICATION

This application claims the benefit of and takes priority from Chinese Patent Application No. 202211664522.2 filed on Dec. 23, 2022, the contents of which are herein incorporated by reference.

### TECHNICAL FIELD

The present disclosure relates to the technical field of heat press machine, in particular to a novel heat press machine.

### BACKGROUND

The heat press machine is configured to heat through the heating plate. By means of a certain pressure, specific temperature and time, a pattern layer on transfer paler and a thermosetting substance are attached to the substrate or infiltrated into the substrate.

As shown in FIG. 1 and FIG. 2, the existing heat press machine includes a base 14. A bottom plate 15 is arranged on the base 14. A rear seat 13 is vertically installed at the rear end of the base 14. The middle of the rear seat 13 is hinged with a pressure arm 12 bent towards the front end of the base 14. The lower end of the pressure arm 12 extends into the base 14 and is connected to the front end of the base 14 through a tension spring 19. A pressure plate 16 is installed on the front side of the upper end of the pressure arm 12, and the back of the pressure arm 12 is hinged with a connecting rod 17 through a first hinge point 110. The upper end of the rear seat 14 is hinged with a rotating rod 18 through a second hinge point 111. The front end of the rotating rod 18 is hinged with a manual pressure rod 11 through a third hinge point 112. The manual pressure rod 11 extends above the pressure arm 12 and is hinged with the connecting rod 17. When the pressure rod 11 is manually pressed, the manual pressure rod 11 is manually pressed and lowered to drive the front end of the pressure arm 12 to move downwards. The bottom end of the pressure arm 12 is driven to open the tension spring 19 until the pressure plate 16 and the bottom plate 15 are closed, as shown in FIG. 2. When the third hinge point 112 is forcibly pressed below the connecting line between the first hinge point 110 and the second hinge point 111, the heat press machine can realize the self-locking function. At this time, the hand can be released, and the heat press machine cannot be opened. After the work is finished, at this time, only the manual pressure rod 11 is lifted forcibly. When the third hinge point 112 is lifted to the upper part of the connecting line of the central points of the first hinge point 110 and the second hinge point 111, the tension spring 19 can pull the pressure arm 12 to drive the connecting rod 17 to ascend, so that the heat pressure machine is opened.

It can be seen that the rack of the heat press machine is one of the main parts of the heat press machine. In the existing heat press machine, the pressure plate and the bottom plate are connected through a plurality of hinge points. The hinge points are easy to loosen and fall off, and the rack structure is complicated, the connection stability is poor, the volume is large, the weight is heavy, the installation and use are not convenient enough, and the cost is high. In addition, the self-locking mechanism for keeping the pressure plate and the bottom plate closed is easy to unlock due to accidental collision, so that the stability is poor.

### SUMMARY

The purpose of the present disclosure is to provide a new novel heat press machine so as to solve the problem of poor structural stability of a rack caused by the connection of a pressure plate and a bottom plate through a plurality of hinge points in the prior art. The novel heat press machine in the present disclosure omits the complicated structures, such as supports, joints and pressure rods, of the traditional heat press machine, and is simple in structure, high in connection stability, small in volume, light in weight and simple and convenient in operation.

Provided is a novel heat press machine. The novel heat press machine includes an upper frame body and a lower frame body. A heating plate is arranged in the upper frame body. A lower plate is arranged in the lower frame body. The rear end of the upper frame body is hinged with the rear end of the lower frame body. An elastic assembly is arranged between the rear end of the upper frame body and the rear end of the lower frame body. The elastic assembly makes the upper frame body and the lower frame body open at an acute angle in a natural state. Self-locking mechanisms are arranged at the front end of the upper frame body and the front end of the lower frame body, the upper frame body is pressed down so that the lower frame body is covered with the upper frame body, and the heating plate and the lower plate are kept closed through the self-locking mechanisms.

As a preferable scheme of the present disclosure, the self-locking mechanism includes a self-locking hook or a self-locking stopper respectively arranged on the upper frame body or the lower frame body. The self-locking hook is rotatably connected to the inner side of the upper frame body or the lower frame body, and the rotation angle of the self-locking hook is limited by a stopper assembly. The self-locking hook is clamped on the self-locking stopper when the lower frame body is covered with the upper frame body.

As a preferable scheme of the present disclosure, the stopper assembly includes a first limited post and a second limited post, and the first limited post and the second limited post are respectively arranged on the two sides of the self-locking hook.

As a preferable scheme of the present disclosure, two self-locking hooks and two self-locking stoppers are arranged, the two self-locking hooks or two self-locking stoppers are respectively arranged on the two sides of the upper frame body or the lower frame body, and the two self-locking hooks are connected through a linkage rod.

As a preferable scheme of the present disclosure, the self-locking stopper is a hanging rod. The two hanging rods are respectively arranged on the two sides of the lower frame body. The self-locking hook is arranged on the upper frame body and extends downwards. The first limited post and the second limited post are respectively arranged on the front and rear sides of the self-locking hook. The linkage rod is connected to the upper ends of the two self-locking hooks. The lower end of the self-locking hook is clamped to the hanging rod.

As a preferable scheme of the present disclosure, the self-locking stopper is a fixed hook. The fixed hook is arranged on the upper frame body and obliquely downwards. The self-locking hook is arranged on the lower frame body and extends transversely. The first limited post and the second limited post are respectively arranged on the upper and lower sides of the self-locking hook. The linkage rod is connected to the front ends of the two self-locking hooks. The fixed hook is clamped to the rear end of the self-locking hook.

As a preferable scheme of the present disclosure, a height adjusting mechanism is arranged in the lower frame body. The height adjusting mechanism is connected to the lower part of the lower plate. The height adjusting mechanism includes an adjusting screw, a front movable rod, a rear movable rod and a bottom support rod. The two ends of the front movable rod are respectively connected to a cross rod. A transverse strip hole is formed in the rear end of the cross rod. The two ends of the rear movable rod are slidably connected with the cross rod through the strip hole. The two ends of the front movable rod are rotatably connected with the two ends of the bottom support rod through first connecting rods. The two ends of the rear movable rod are rotatably connected with the two ends of the bottom support rod through second connecting rods. The bottom support rod abuts against the lower frame body, the front section of the adjusting screw is provided with an external thread. A threaded hole matched with the external thread is formed in the front movable rod. The front section of the adjusting screw passes through the threaded hole. The rear end of the adjusting screw is rotatably connected with the rear movable rod. The rotation of the adjusting screw drives the rear movable rod to move back and forth along the strip hole.

As a preferable scheme of the present disclosure, connecting seats are arranged at the rear end of the upper frame body and the rear end of the lower frame body. The elastic assembly includes a connecting rod and an extension spring. The extension spring sleeves the connecting rod and is arranged between the upper and lower connecting seats. The upper and lower ends of the connecting rod respectively pass through the two connecting seats, and the two ends of the connecting rod are respectively movably connected with the upper and lower connecting seats through baffle plates.

As a preferable scheme of the present disclosure, a handle is arranged at the front end of the upper frame body.

As a preferable scheme of the present disclosure, an insulation board is arranged in the upper frame body. The insulation board is arranged between the upper frame body and the heating plate. A control instrument is arranged in the upper frame body. The control instrument is arranged on the upper side of the insulation board. A power switch mounting box is arranged at the rear end of the lower frame body. The heating plate and the control instrument are both connected with the power switch mounting box.

As a preferable scheme of the present disclosure, the heating plate includes a heating box body and a heating tube. The heating tube is spirally arranged in the heating box body and abuts against the bottom surface of the heating box body. The heating tube is connected to the heating box body through a plurality of fixed plates. A fixed groove matched with the heating tube is formed in the fixed plate. When the fixed plate is used for connecting the heating tube to the heating box body, the heating tube passes through the fixed groove.

As a preferable scheme of the present disclosure, a supporting mechanism is arranged in the heating box body. The supporting mechanism includes a plurality of transverse partition plates and a plurality of longitudinal partition plates. The transverse partition plates and the longitudinal partition plates are arranged in a crossed manner. A plurality of supporting grids are formed in the heating box body. Notches for the heating tube to pass through are formed in the bottom sides of the transverse partition plate and the longitudinal partition plate. The heating tube passes through the notches.

As a preferable scheme of the present disclosure, the transverse partition plate and the longitudinal partition plate both include a connecting edge and a supporting edge, the connecting edge is vertically connected with the supporting edge, the connecting edge abuts against the bottom surface of the heating box body and is connected with the bottom surface of the heating box body, and the supporting edge is vertical to the bottom surface of the heating box body.

Compared with the prior art, the present disclosure has the following beneficial effects.

Provided is a novel heat press machine. The novel heat press machine includes an upper frame body and a lower frame body. A heating plate is arranged in the upper frame body. A lower plate is arranged in the lower frame body. The rear end of the upper frame body is hinged with the rear end of the lower frame body. An elastic assembly is arranged between the rear end of the upper frame body and the rear end of the lower frame body. The elastic assembly makes the upper frame body and the lower frame body open at an acute angle in a natural state. Self-locking mechanisms are arranged at the front end of the upper frame body and the front end of the lower frame body, the upper frame body is pressed down so that the lower frame body is covered with the upper frame body, and the heating plate and the lower plate are kept closed through the self-locking mechanisms. According to the heat press machine in the present disclosure, the heating plate and the lower plate are hinged only through the upper frame body and the lower frame body. When the heating plate and the lower plate are closed, only the upper frame body needs to be rotated to the lower frame body, so that the heat press machine omits the complicated structures, such as supports, joints and pressure rods, of the traditional heat press machine, and is simple in structure, high in connection stability, small in volume, light in weight and simple and convenient in operation. The upper frame body and the lower frame body are propped up through the elastic assembly so that the upper frame body and the lower frame body are in an open state. After the upper frame body is pressed to close the heating plate and the lower plate, the closed state of the heating plate and the lower plate is maintained by the self-locking mechanism. When the heating plate and the lower plate are closed, the thickness of the heat press machine is thin. The self-locking mechanism is simple to install, compact in structure and small in occupied space. The thickness of the heat press machine after the heating plate and the lower plate are closed cannot be influenced, and the structure stability is high.

### BRIEF DESCRIPTION OF THE DRAWINGS

To describe the technical solutions in the embodiments of the present disclosure or in the prior art more clearly, the following briefly describes the attached figures required for describing the embodiments or the prior art. Apparently, the attached figures in the following description show merely some embodiments of the present disclosure, and a person of ordinary skill in the art may derive other drawings from these attached figures without creative efforts.

FIG. 1 is a structural schematic diagram of an existing heat press machine in a closed state;

FIG. 2 is a structural schematic diagram of an existing heat press machine in an open state;

FIG. 3 is a structural schematic diagram of a novel heat press machine in an open state in the first embodiment;

FIG. 4 is a structural schematic diagram of a novel heat press machine in a closed state in the first embodiment;

FIG. 5 is a structural schematic diagram of the rear side of a novel heat press machine in a closed state in the first embodiment;

FIG. 6 is a structural schematic diagram of a tension spring and self-locking hooks of a novel heat press machine in an open state in the first embodiment;

FIG. 7 is a structural schematic diagram of a height adjusting mechanism in the first embodiment;

FIG. 8 is a state diagram of a height adjusting mechanism during ascending in the first embodiment;

FIG. 9 is a state diagram of a height adjusting mechanism during descending in the first embodiment;

FIG. 10 is a state diagram of an open self-locking hook when a novel heat press machine is closed in the first embodiment;

FIG. 11 is a state diagram of an extension spring and a self-locking hook after a novel heat press machine is closed in the first embodiment;

FIG. 12 is a structural schematic diagram of a novel heat press machine in an open state in the second embodiment;

FIG. 13 is a structural schematic diagram of a novel heat press machine in a closed state in the second embodiment;

FIG. 14 is a state diagram of an open self-locking hook when a novel heat press machine is closed in the second embodiment;

FIG. 15 is a state diagram of an extension spring and a self-locking hook after a novel heat press machine is closed in the second embodiment;

FIG. 16 is an internal structure chart of a heating plate in the first embodiment;

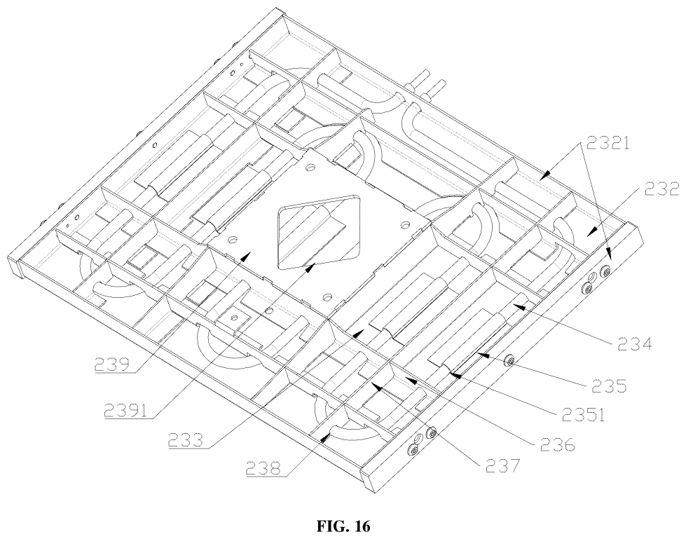

FIG. 17 is a schematic diagram of the connection among a heating tube, a supporting mechanism and a fixed plate in the first embodiment; and

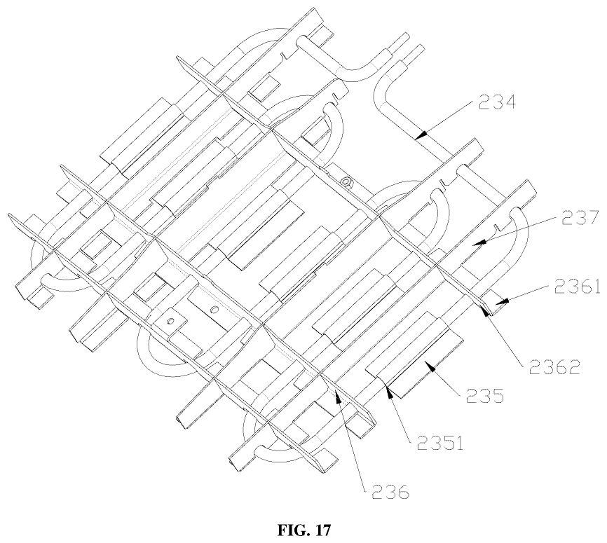

FIG. 18 is a structural schematic diagram of a heating box body in the first embodiment.

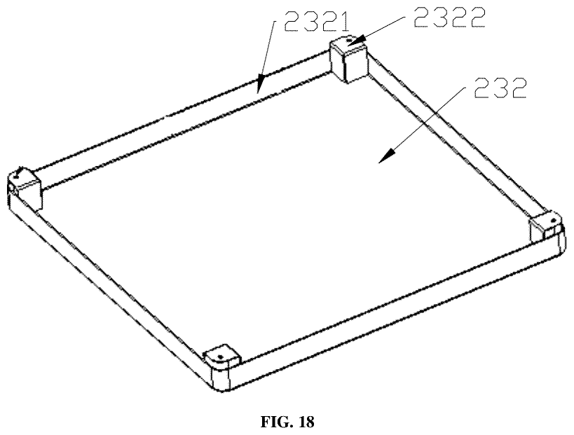

Reference signs: 11, manual pressure rod; 12, pressure arm; 13, rear seat; 14, base; 15, bottom plate; 16, pressure plate; 17, connecting rod; 18, rotating rod; 19, tension spring; 110, first hinge point; 111, second hinge point; 112, third hinge point; 21, lower frame body; 211, front supporting rod; 212, rear supporting rod; 22, upper frame body; 221, instrument mounting plate; 222, handle; 223, handle hole; 224, ventilation opening; 225, connecting seat; 23, heating plate; 231, insulation board; 232, heating box body; 2321, edge plate; 2322, supporting pillar; 233, supporting grid; 234, heating tube; 235, fixed plate; 2351, fixed groove; 236, transverse partition plate; 2361, connecting edge; 2362, supporting edge; 237, longitudinal partition plate; 238, notch; 239, supporting top plate; 2391, radiating opening; 24, lower plate; 241, lower supporting plate; 25, elastic assembly; 251, extension spring; 252, connecting rod; 253, baffle plate; 26, self-locking hook; 261, linkage rod; 262, first limited post; 263, second limited post; 271, hanging rod; 272, fixed hook; 28, height adjusting mechanism; 281, adjusting knob; 282, adjusting screw; 2821, external thread; 283, front movable rod; 284, rear movable rod; 285, bottom support rod; 286, cross rod; 2861, strip hole; 287, first connecting rod; 288, second connecting rod; and 29, power switch mounting box.

### DETAILED DESCRIPTION OF THE EMBODIMENTS

In the description of the present disclosure, it needs to be illustrated that, except as otherwise noted, the meaning of “a plurality of” is two or more than two; and the indicative direction or position relations of the terms such as “upper”, “lower”, “front”, “rear”, “left”, “right”, “top”, “bottom”, “inside”, “outside”, “front end”, “rear end”, “head” and “tail” are direction or position relations illustrated based on the accompanying diagrams, just for facilitating the description of the present disclosure and simplifying the description, but not for indicating or hinting that the indicated device or element must be in a specific direction and is constructed and operated in the specific direction, the terms cannot be understood as the restriction of the present disclosure. Moreover, the terms such as “first”, “second” and “third” are just used for distinguishing the description, but cannot be understood to indicate or hint relative importance.

In the description of the present disclosure, it further needs to be illustrated that, except as otherwise noted, the terms such as “mount”, “link” and “connect” should be generally understood, for example, the components can be fixedly connected, and also can be detachably connected or integrally connected; the components can be mechanically connected, and also can be electrically connected; the components can be directly connected, also can be indirectly connected through an intermediate. For those skilled in the art, the specific meanings of the terms in the present disclosure can be understood according to specific conditions.

The following further describes specific embodiments of the present disclosure with reference to the following attached figures.

### Embodiment I

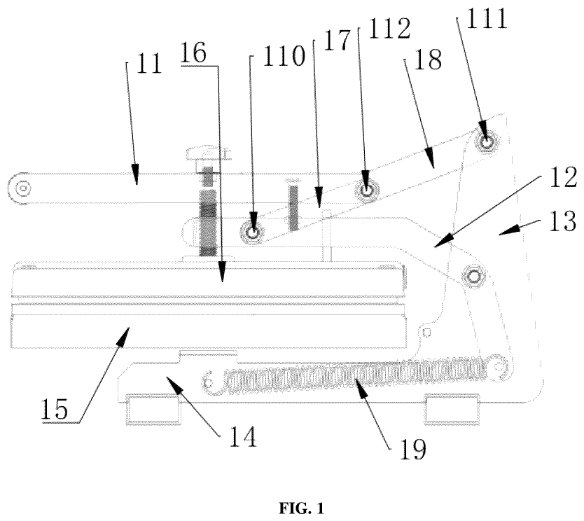

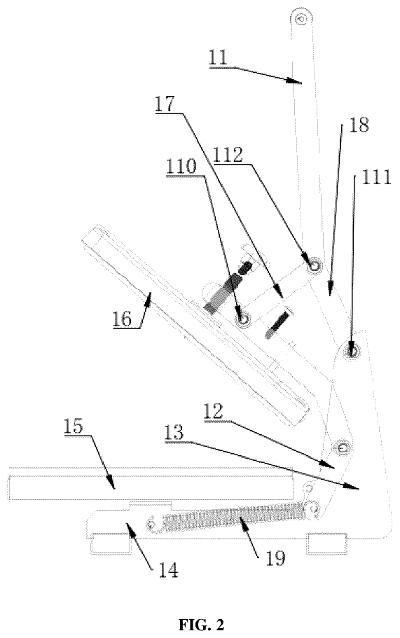

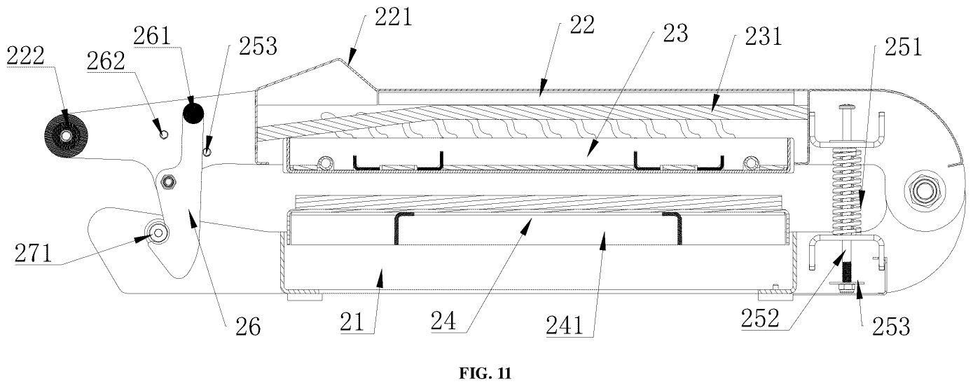

The embodiment provides a novel heat press machine. As shown in FIG. 1 to FIG. 11, the novel heat press machine includes an upper frame body 22 and a lower frame body 21. A heating plate 23 is arranged in the upper frame body 22, and a lower plate 24 is arranged in the lower frame body 21. The rear end of the upper frame body 22 is hinged with the rear end of the lower frame body 21, and an elastic assembly 25 is arranged between the rear end of the upper frame body 22 and the rear end of the lower frame body 21. The elastic assembly 25 makes the upper frame body 22 and the lower frame body 21 open at an acute angle in a natural state. Self-locking mechanisms are arranged at the front end of the upper frame body 22 and the front end of the lower frame body 21, the upper frame body 22 is pressed down so that the lower frame body 21 is covered with the upper frame body 22, and the heating plate 23 and the lower plate 24 are kept closed through the self-locking mechanisms.

The heat press machine in the embodiment is provided with the upper frame body 22 and the lower frame body 21, and the upper frame body 22 and the lower frame body 21 are hinged at the rear end, so that the upper frame body 22 and the lower frame body 21 are easy to open and close. The heating plate 23 and the lower plate 24 are hinged with the lower frame body 21 only through the upper frame body 22. When the heating plate 23 and the lower plate 24 are closed, only the upper frame body 22 needs to rotate to the lower frame body 21, and the novel heat press machine omits complicated structures, such as supports, joints and pressure rods, of the traditional heat press machine and is simple in structure, high in connection stability, small in volume, light in weight and simple and convenient in operation. The upper frame body 22 and the lower frame body 21 are propped up through the elastic assembly 25 so that the upper frame body 22 and the lower frame body 21 are in an open state. After the upper frame body 22 is pressed to close the heating plate 23 and the lower plate 24, the closed state of the heating plate 23 and the lower plate 24 is maintained by the self-locking mechanism. When the heating plate 23 and the lower plate 24 are closed, the thickness of the heat press machine is thin. The self-locking mechanism is simple to install, compact in structure and small in occupied space. The thickness of the heat press machine after the heating plate 23 and the lower plate 24 are closed cannot be influenced, and the structure stability is high.

Preferably, the self-locking mechanism includes a self-locking hook 26 or a self-locking stopper respectively arranged on the upper frame body 22 or the lower frame body 21, the self-locking hook 26 is rotatably connected to the inner side of the upper frame body 22 or the lower frame body 21, the rotation angle of the self-locking hook 26 is limited by a stopper assembly, and the self-locking hook 26 is clamped on the self-locking stopper when the lower frame body 21 is covered with the upper frame body 22.

The self-locking mechanism in the embodiment is simple in structure and convenient in self-locking by clamping the self-locking hook 26 with the self-locking stopper, so that the connection between the upper frame body 22 and the lower frame body 21 is high in stability, and the heating plate 23 and the lower plate 24 are kept closed.

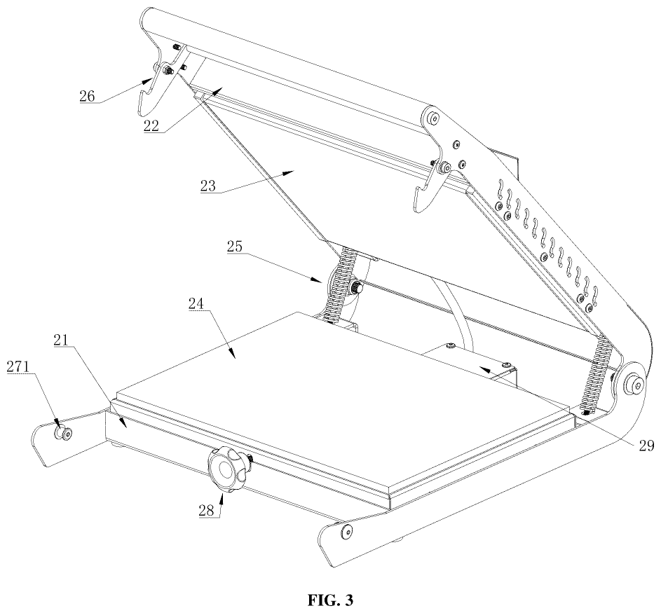

Preferably, as shown in FIG. 3, the stopper assembly includes a first limited post 262 and a second limited post 263, and the first limited post 262 and the second limited post 263 are respectively arranged on the two sides of the self-locking hook 26. The distance between the first limited post 262 and the second limited post 263 is greater than the width of the self-locking hook 26, so that the self-locking hook 26 can swing between the first limited post 262 and the second limited post 263. The self-locking hook 26 can automatically adjust the angle of the hook to clamp the self-locking stopper, and the hook on the self-locking hook 26 can also be released from the self-locking stopper conveniently during unlocking.

Preferably, two self-locking hooks 26 and two self-locking stoppers are arranged, the two self-locking hooks 26 or two self-locking stoppers are respectively arranged on the two sides of the upper frame body 22 or the lower frame body 21, and the two self-locking hooks 26 are connected through a linkage rod 261. The relative connection between the two self-locking hooks 26 and the self-locking stopper makes the connection more stable, and the linkage rod 261 drives the self-locking hooks 26 on the two sides to be clamped with the self-locking stopper at the same time.

Preferably, as shown in FIG. 3 to FIG. 6, the self-locking stopper is a hanging rod 271, the two hanging rods 271 are respectively arranged on the two sides of the lower frame body 21, the self-locking hook 26 is arranged on the upper frame body 22 and extends downwards, the first limited post 262 and the second limited post 263 are respectively arranged on the front and rear sides of the self-locking hook 26, the linkage rod 261 is connected to the upper ends of the two self-locking hooks 26, and the lower end of the self-locking hook 26 is clamped to the hanging rod 271.

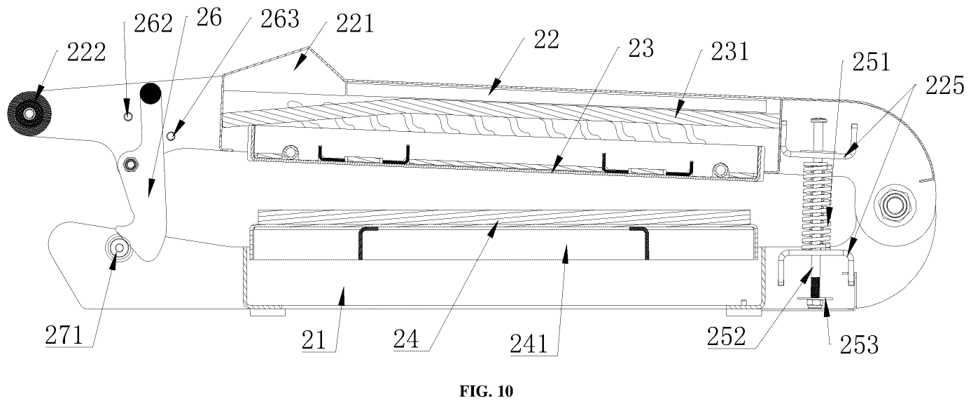

In the embodiment, the heating plate 23 and the lower plate 24 are closed, as shown in FIG. 10. When the upper frame body 22 is pressed down, the self-locking hook 26 collides with the hanging rod 271, the self-locking hook 26 can rotate counterclockwise, and the maximum rotation angle is limited within a suitable range by the first limited post 262. When the self-locking hook 26 completely reaches the range that the hanging rod 271 can be hooked, the self-locking hook 26 can rotate clockwise automatically or under the traction of the external elastic assembly 25 and is finally clamped to the hanging rod 271, so that the self-locking function is realized. When the heat press machine needs to be turned on after work, the self-locking hook 26 can be disengaged from the hanging rod 271 only by manually moving the linkage rod 261 to the front side, so that the upper frame body 22 of the heat press machine can be opened relative to the lower frame body 21 under the action of the elastic assembly 25.

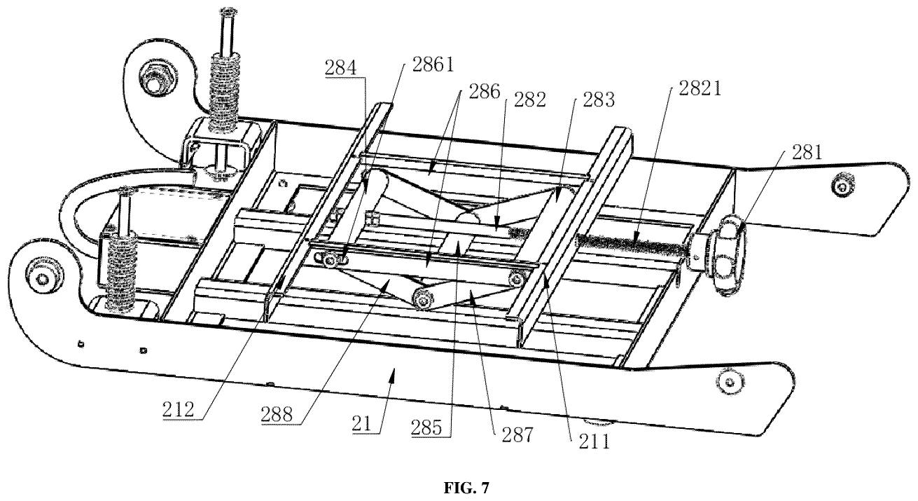

Preferably, as shown in FIG. 7 to FIG. 9, a height adjusting mechanism 28 is arranged in the lower frame body, and the height adjusting mechanism 28 is connected to the lower part of the lower plate 24. The height adjusting mechanism 28 is configured to adjust the height of the lower plate 24 in the lower frame body 21. The height adjusting mechanism 28 includes an adjusting screw 282, a front movable rod 283, a rear movable rod 284 and a bottom support rod 285, the two ends of the front movable rod 283 are respectively connected to a cross rod 286, a transverse strip hole 2861 is formed in the rear end of the cross rod 286, the two ends of the rear movable rod 284 are slidably connected with the cross rod 286 through the strip hole 2861. The two ends of the front movable rod 283 are rotatably connected with the two ends of the bottom support rod 285 through first connecting rods 287. The two ends of the rear movable rod 284 are rotatably connected with the two ends of the bottom support rod 285 through second connecting rods 288. The bottom support rod 285 abuts against the lower frame body 21. The front section of the adjusting screw 282 is provided with an external thread 2821, a threaded hole matched with the external thread 2821 is formed in the front movable rod 283, the front section of the adjusting screw 282 passes through the threaded hole, the rear end of the adjusting screw 282 is rotatably connected with the rear movable rod 284, and the rotation of the adjusting screw 282 drives the rear movable rod 284 to move back and forth along the strip hole 2861. The front and rear ends of the cross rod 286 are respectively connected with a front supporting rod 211 and a rear supporting rod 212, the front supporting rod 211 and the rear supporting rod 212 are connected to the lower side of a lower supporting plate 241, and the lower supporting plate 241 is arranged on the lower side of the lower plate 24 to support and fix the lower plate. An adjusting knob 281 is arranged at one end of the adjusting screw 282, and the adjusting knob is arranged outside the lower frame body 21.

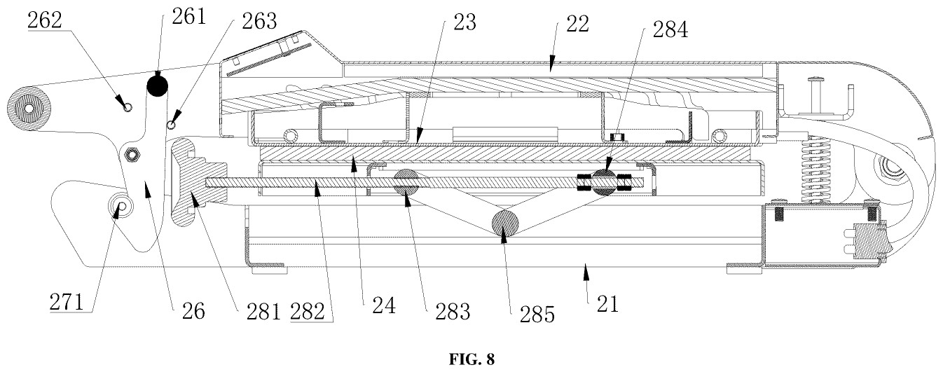

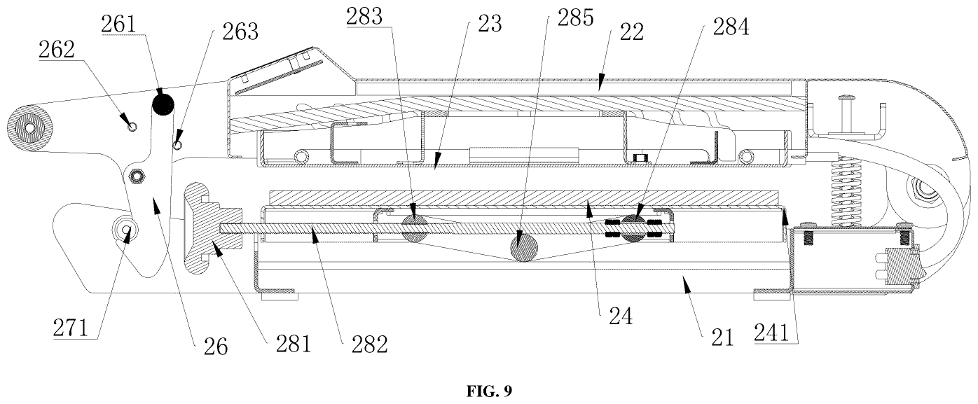

In the embodiment, when the height adjusting mechanism 28 adjusts the height of the lower plate 24 in the lower frame body 21, the adjusting knob 281 is rotated, and the adjusting screw 282 rotates to drive the rear movable rod 284 to move back and forth along the strip hole 2861. The cross rod 286, the first connecting rod 287 and the second connecting rod 288 are connected in a triangular supporting structure, and then the included angle between the first connecting rod and the second connecting rod is changed. Therefore, the vertical height between the cross rod 286 and the bottom support rod 285 is adjusted, so that the front supporting rod 211 and the rear supporting rod 212 drive the lower plate 24 to move up and down. As shown in FIG. 8, when the adjusting knob is rotated, the adjusting screw 282 rotates to drive the rear movable rod 284 to move backwards along the strip hole 2861, and the included angle between the first connecting rod 287 and the second connecting rod 288 is increased, so that the vertical height between the cross rod 286 and the bottom support rod 285 is decreased. Therefore, the front supporting rod 211 and the rear supporting rod 212 drive the lower plate 24 to move downwards, and the lower plate 24 moves to the position as shown in FIG. 9, so that the distance between the lower plate 24 in the closed state and the heating plate 23 is increased.

Preferably, as shown in FIG. 10, connecting seats 225 are arranged at the rear end of the upper frame body 22 and the rear end of the lower frame body 21. The elastic assembly 25 includes a connecting rod 252 and an extension spring 251, the extension spring 251 sleeves the connecting rod 252 and is arranged between the upper and lower connecting seats 225, the upper and lower ends of the connecting rod 252 respectively pass through the two connecting seats 225, and the two ends of the connecting rod 252 are respectively movably connected with the upper and lower connecting seats 225 through baffle plates 253.

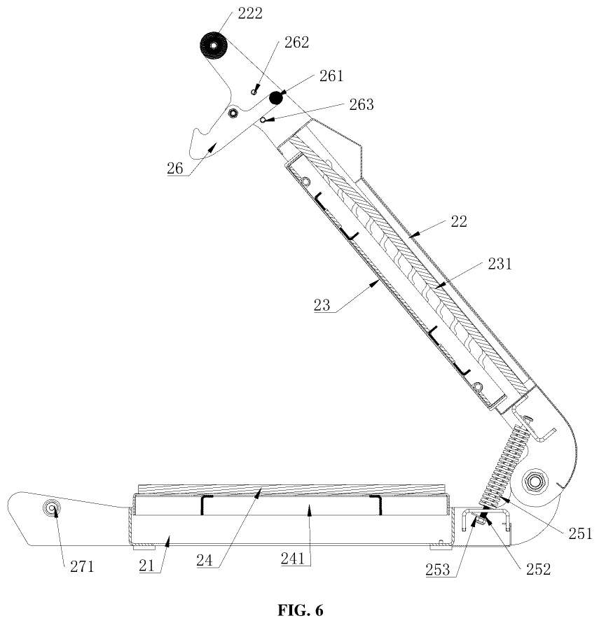

In the natural state, the extension spring 251 spreads the upper frame body 22 relative to the lower frame body 21, and the upper frame body 22 and the lower frame body 21 are connected at an acute angle. As shown in FIG. 6, the two baffle plates 253 are respectively blocked in the upper and lower connecting seats 225 and are arranged at the top and bottom ends of the connecting rod 252. When the upper frame body 22 is pressed down, as shown in FIG. 10, the extension spring 251 is compressed.

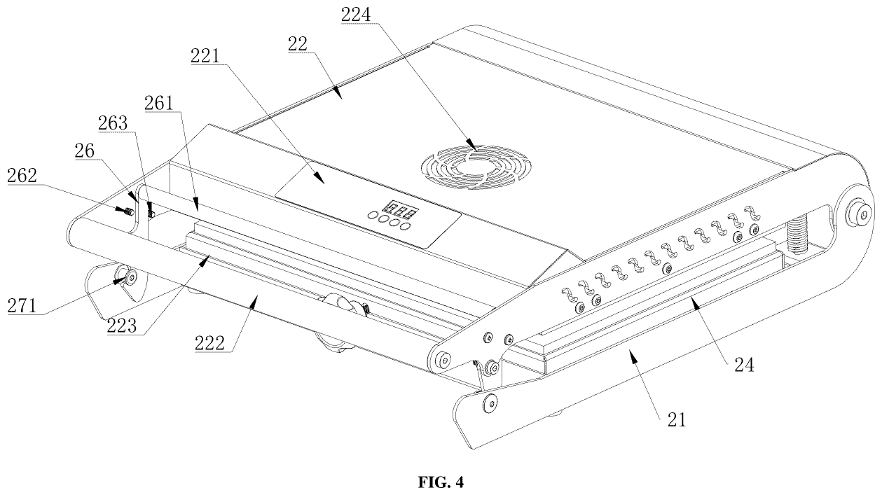

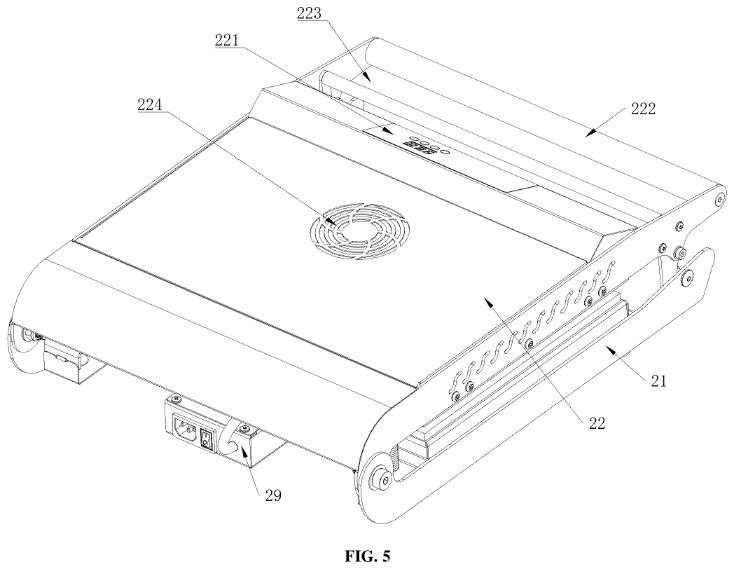

Preferably, as shown in FIG. 4 and FIG. 5, a handle 222 is arranged at the front end of the upper frame body 22. The handle 222 can conveniently press the upper frame body 22 by hand. A handle hole 223 is formed in the rear side of the handle 222, and the linkage rod 261 penetrates into the handle hole 223. When the linkage rod 261 is moved to unlock, the linkage rod 261 can be moved to one side of the handle 222 by means of the handle 222.

Preferably, an insulation board 231 is arranged in the upper frame body 22, the insulation board 231 is arranged between the upper frame body 22 and the heating plate 23, and the insulation board 231 is configured to prevent the temperature of the heating plate 23 from being transmitted to the upper frame body 22. A control instrument is arranged in the upper frame body 22, the control instrument is arranged on the upper side of the insulation board 231, a power switch mounting box 29 is arranged at the rear end of the lower frame body 21, and the heating plate 23 and the control instrument are both connected with the power switch mounting box 29. An instrument mounting plate 221 is arranged on the upper surface of the upper frame body 22, the control instrument is arranged on the lower side of the instrument mounting plate 221, and the control instrument is configured to control the working state of the heat press machine. The power switch mounting box 29 is configured to connect an external power supply to supply power to the heat press machine. A ventilation opening 224 is formed in the upper frame body 22 for radiating heat.

Preferably, the heating plate 23 includes a heating box body 232 and a heating tube 234, the heating tube 234 is spirally arranged in the heating box body 232 and abuts against the bottom surface of the heating box body 232, and the heating tube 234 is connected to the heating box body 235 through a plurality of fixed plates 235. A fixed groove 2351 matched with the heating tube 234 is formed in the fixed plate 235, and when the fixed plate 235 is used for connecting the heating tube 234 to the heating box body 232, the heating tube 234 passes through the fixed groove 2351. The heating box body 232 includes a bottom surface and edge plates 2321, and the edge plates 2321 are vertically connected to the periphery of the bottom surface. The heating box body 232 can be formed by stamping or bending an iron plate. The fixed plate 235 and the bottom surface of the heating box body 232 can be connected by welding or screwing. The bottom surface of the heating plate 23 is provided corresponding to the lower plate 24.

In the embodiment, the heating plate 23 is used for connecting the heating tube 234 into the heating box body 232 through the fixed plates 235, and the arrangement of the heating tube 234 in the heating box body 232 is convenient to adjust. When the size and shape of the heating plate 23 are changed, the heating tube 234 is also conveniently taken off to be connected with heating box bodies 232 with different shapes and sizes to form the required heating plate 23. In the embodiment, the heating plate 23 is simple in structure, light and practical. The traditional heating plate is generally cast so that the electric heating tube is fixedly installed on the shell, and then an integral structure is formed. When the heating plate is machined, it is necessary to use expensive large casting molds and die-casting machine tools. Once the size or shape of the heating plate needs to be changed or the heating plate needs to be slightly modified, the completed molds can be invalid to result in great losses. In the embodiment, the heating plate 23 solves the technical problem that in the prior art, most of the electric heating plates are cast, and the heating tube is fixed on the shell to form a whole, so that the size and shape are inconvenient to change.

Preferably, a supporting mechanism is arranged in the heating box body 232, the supporting mechanism includes a plurality of transverse partition plates 236 and a plurality of longitudinal partition plates 237, the transverse partition plates 236 and the longitudinal partition plates 237 are arranged in a crossed manner, and a plurality of supporting grids 233 are formed in the heating box body 232. Notches 238 for the heating tube to pass through are formed in the bottom sides of the transverse partition plate 236 and the longitudinal partition plate 237, and the heating tube 234 passes through the notches 238. The insulation board 231 is arranged on the upper side of the heating box body 232, and the transverse partition plate 236 and the longitudinal partition plate 237 play a role in supporting the insulation board 231 to avoid direct contact between the insulation board 231 and the heating tube 234, and the heating tube 234 can facilitate to radiate heat.

Preferably, a supporting top plate 239 is arranged on the upper side of one supporting grid 233 in the middle of the heating box body 232, and a radiating opening 2391 is formed in the middle of the supporting top plate 239. The supporting top plate 239 plays a role in supporting the middle area of the heating box body 232. The supporting top plate 239 is clamped with the transverse partition plate 236 and the longitudinal partition plate 237 on the side wall of the supporting grid 233 to facilitate the disassembly and assembly of the supporting top plate 239. The supporting mechanism further includes a plurality of supporting pillars 2322, and the supporting pillars 2322 are respectively arranged at the corners of the heating box body 232 to support the corners of the heating box body 232.

Preferably, the transverse partition plate 236 and the longitudinal partition plate 237 both include a connecting edge 2361 and a supporting edge 2362, the connecting edge 2361 is vertically connected with the supporting edge 2362, the connecting edge 2361 abuts against the bottom surface of the heating box body 232 and is connected with the bottom surface of the heating box body 232, and the supporting edge 2362 is vertical to the bottom surface of the heating box body 232. The connecting edge 2361 is welded to the bottom surface of the heating box body 232 or connected by screws. The connection between the connecting edge 2361 and the heating box body 232 is high in stability, so that the supporting edge 2362 has a good supporting function, and the overall stability of the heating plate 23 is good.

In the embodiment, when the heat press machine is used, firstly, a power cord is plugged, a switch is turned on, and a controller screen installed on the instrument mounting plate 221 shows the required temperature and time, and then the heat press machine starts to heat up. The handle 222 is pressed with both hands or one hand to hook the self-locking hook with the self-locking stopper. The tightness degree of pressing between the heating plate 23 and the lower plate 24 is confirmed. Before pressing, a piece of A4 paper can be pressed around the heating plate 23 in combination with the lower plate 24. After pressing, the paper is pulled. If the paper is easily pulled out, the pressure is not enough. When the paper cannot be pulled or pulled out, the pressure is appropriate. When the pressure is not enough, the adjusting knob 281 is rotated counterclockwise until the pressure is appropriate. After the temperature rises to a set temperature, a hot stamping product and a picture are put on the lower plate 24, and then the lower handle 222 is pressed with both hands or one hand to hook the self-locking hook with the self-locking stopper. And then, a timer button on the display screen is pressed to start timing. When the time is up, the handle 222 and the linkage rod 261 are hold with both hands, and the self-locking hook is disengaged from the self-locking stopper, and the heat press machine is opened to take out the hot stamping product, and the work is completed.

### Embodiment II

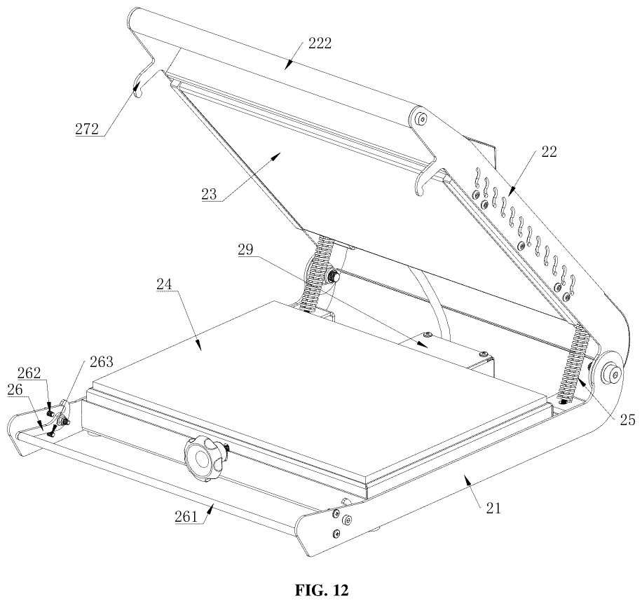

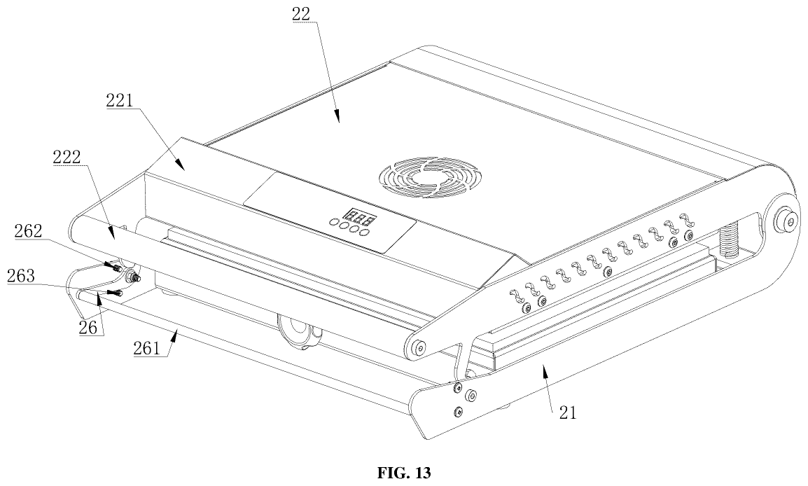

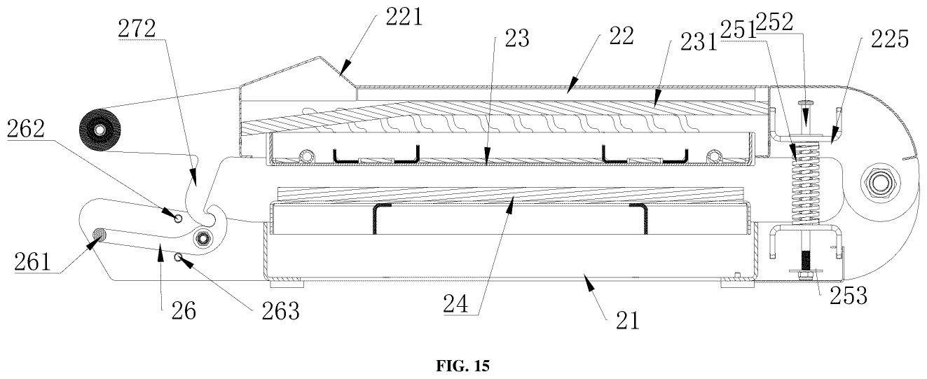

The difference between the heat press machine provided in the embodiment and the heat press machine in the first embodiment is as follows. As shown in FIG. 12 to FIG. 15, in the embodiment, the self-locking stopper is a fixed hook 272, the fixed hook 272 is arranged on the upper frame body 22 and obliquely downwards, the self-locking hook 26 is arranged on the lower frame body 21 and extends transversely, the first limited post 262 and the second limited post 263 are respectively arranged on the upper and lower sides of the self-locking hook 26, the linkage rod 261 is connected to the front ends of the two self-locking hooks 26, and the fixed hook 272 is clamped to the rear end of the self-locking hook 26.

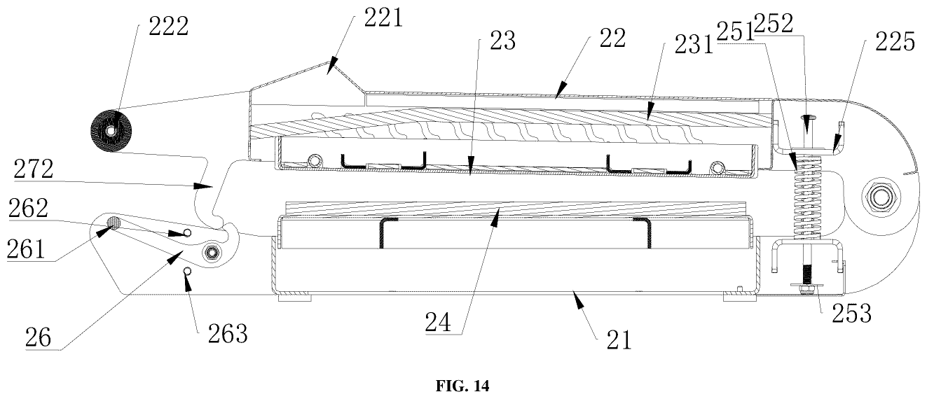

In the embodiment, the heating plate 23 and the lower plate 24 are closed, as shown in FIG. 14. When the upper frame body 22 is pressed down, the fixed hook 272 collides with the self-locking hook 26, the self-locking hook 26 can rotate clockwise, and the maximum rotation angle is limited within a suitable range by the second limited post 263. When the self-locking hook 26 completely reaches the range that the fixed hook 272 can be hooked, the self-locking hook 26 can rotate counterclockwise automatically or under the traction of the external elastic assembly 25 and is finally clamped to the fixed hook 272, so that the self-locking function is realized. When the heat press machine needs to be turned on after work, the self-locking hook 26 can be disengaged from the fixed hook 272 only by manually moving the linkage rod 261 to the front side, so that the upper frame body 22 of the heat press machine can be opened relative to the lower frame body 21 under the action of the elastic assembly 25.

The foregoing descriptions are merely specific embodiments of the present disclosure, but are not intended to limit the protection scope of the present disclosure. A number of deformations and improvements readily figured out by a person skilled in the art within the technical scope disclosed in the present disclosure shall fall within the protection scope of the present disclosure on the premise of not deviating from the inventive concept of the present disclosure.

What is claimed is:

1. A novel heat press machine, comprising an upper frame body (22) and a lower frame body (21), wherein a heating plate (23) is arranged in the upper frame body (22), a lower plate (24) is arranged in the lower frame body (21), the rear end of the upper frame body (22) is hinged with the rear end of the lower frame body (21), and an elastic assembly (25) is arranged between the rear end of the upper frame body (22) and the rear end of the lower frame body (21); the elastic assembly (25) makes the upper frame body (22) and the lower frame body (21) open at an acute angle in a natural state; and self-locking mechanisms are arranged at the front end of the upper frame body (22) and the front end of the lower frame body (21), the upper frame body (22) is pressed down so that the lower frame body (21) is covered with the upper frame body (22), and the heating plate (23) and the lower plate (24) are kept closed through the self-locking mechanisms.

2. The novel heat press machine according to claim 1, wherein the self-locking mechanism comprises a self-locking hook (26) or a self-locking stopper respectively arranged on the upper frame body (22) or the lower frame body (21), the self-locking hook (26) is rotatably connected to the inner side of the upper frame body (22) or the lower frame body (21), the rotation angle of the self-locking hook (26) is limited by a stopper assembly, and the self-locking hook (26) is clamped on the self-locking stopper when the lower frame body (21) is covered with the upper frame body (22).

3. The novel heat press machine according to claim 2, wherein the stopper assembly comprises a first limited post (262) and a second limited post (263), and the first limited post (262) and the second limited post (263) are respectively arranged on the two sides of the self-locking hook (26).

4. The novel heat press machine according to claim 3, wherein two self-locking hooks (26) and two self-locking stoppers are arranged, the two self-locking hooks (26) or two self-locking stoppers are respectively arranged on the two sides of the upper frame body (22) or the lower frame body (21), and the two self-locking hooks (26) are connected through a linkage rod (261).

5. The novel heat press machine according to claim 4, wherein the self-locking stopper is a hanging rod (271), the two hanging rods (271) are respectively arranged on the two sides of the lower frame body (21), the self-locking hook (26) is arranged on the upper frame body (22) and extends downwards, the first limited post (262) and the second limited post (263) are respectively arranged on the front and rear sides of the self-locking hook (26), the linkage rod (261) is connected to the upper ends of the two self-locking hooks (26), and the lower end of the self-locking hook (26) is clamped to the hanging rod (271).

6. The novel heat press machine according to claim 4, wherein the self-locking stopper is a fixed hook (272), the fixed hook (272) is arranged on the upper frame body (22) and obliquely downwards, the self-locking hook (26) is arranged on the lower frame body (21) and extends transversely, the first limited post (262) and the second limited post (263) are respectively arranged on the upper and lower sides of the self-locking hook (26), the linkage rod (261) is connected to the front ends of the two self-locking hooks (26), and the fixed hook (272) is clamped to the rear end of the self-locking hook (26).

7. The novel heat press machine according to claim 5, wherein a height adjusting mechanism (28) is arranged in the lower frame body, the height adjusting mechanism (28) is connected to the lower part of the lower plate (24), the height adjusting mechanism (28) comprises an adjusting screw (282), a front movable rod (283), a rear movable rod (284) and a bottom support rod (285), the two ends of the front movable rod (283) are respectively connected to a cross rod (286), a transverse strip hole (2861) is formed in the rear end of the cross rod (286), the two ends of the rear movable rod (284) are slidably connected with the cross rod (286) through the strip hole (2861), the two ends of the front movable rod (283) are rotatably connected with the two ends of the bottom support rod (285) through first connecting rods (287), the two ends of the rear movable rod (284) are rotatably connected with the two ends of the bottom support rod (285) through second connecting rods (288), the bottom support rod (285) abuts against the lower frame body (21), the front section of the adjusting screw (282) is provided with an external thread (2821), a threaded hole matched with the external thread (2821) is formed in the front movable rod (283), the front section of the adjusting screw (282) passes through the threaded hole, the rear end of the adjusting screw (282) is rotatably connected with the rear movable rod (284), and the rotation of the adjusting screw (282) drives the rear movable rod (284) to move back and forth along the strip hole (2861).

8. The novel heat press machine according to claim 5, wherein connecting seats (225) are arranged at the rear end of the upper frame body (22) and the rear end of the lower frame body (21), the elastic assembly (25) comprises a connecting rod (252) and an extension spring (251), the extension spring (251) sleeves the connecting rod (252) and is arranged between the upper and lower connecting seats (225), the upper and lower ends of the connecting rod (252) respectively pass through the two connecting seats (225), and the two ends of the connecting rod (252) are respectively movably connected with the upper and lower connecting seats (225) through baffle plates.

9. The novel heat press machine according to claim 1, wherein a handle (222) is arranged at the front end of the upper frame body (22).

10. The novel heat press machine according to claim 1, wherein an insulation board (231) is arranged in the upper frame body (22), the insulation board (231) is arranged between the upper frame body (22) and the heating plate (23), a control instrument is arranged in the upper frame body (22), the control instrument is arranged on the upper side of the insulation board (231), a power switch mounting box (29) is arranged at the rear end of the lower frame body (21), and the heating plate (23) and the control instrument are both connected with the power switch mounting box (29).

11. The novel heat press machine according to claim 1, wherein the heating plate (23) comprises a heating box body (232) and a heating tube (234), the heating tube (234) is spirally arranged in the heating box body (232) and abuts against the bottom surface of the heating box body (232), the heating tube (234) is connected to the heating box body (235) through a plurality of fixed plates (235), a fixed groove (2351) matched with the heating tube (234) is formed in the fixed plate (235), and when the fixed plate (235) is used for connecting the heating tube (234) to the heating box body (232), the heating tube (234) passes through the fixed groove (2351).

12. The novel heat press machine according to claim 11, wherein a supporting mechanism is arranged in the heating box body (232), the supporting mechanism comprises a plurality of transverse partition plates (236) and a plurality of longitudinal partition plates (237), the transverse partition plates (236) and the longitudinal partition plates (237) are arranged in a crossed manner, a plurality of supporting grids (233) are formed in the heating box body (232), notches (238) for the heating tube to pass through are formed in the bottom sides of the transverse partition plate (236) and the longitudinal partition plate (237), and the heating tube (234) passes through the notches (238).

13. The novel heat press machine according to claim 12, wherein the transverse partition plate (236) and the longitudinal partition plate (237) both comprise a connecting edge (2361) and a supporting edge (2362), the connecting edge (2361) is vertically connected with the supporting edge (2362), the connecting edge (2361) abuts against the bottom surface of the heating box body (232) and is connected with the bottom surface of the heating box body (232), and the supporting edge (2362) is vertical to the bottom surface of the heating box body (232).
